(19) United States
(12) Patent Application Publication
(10) Pub. No.: US 2026/0138525 A1
(43) Pub. Date: May 21, 2026

(54) LAMP CONTROL SYSTEM, LAMP CONTROL METHOD, AND VEHICLE

(71) Applicant: HYUNDAI MOBIS CO., LTD., Seoul (KR)

(72) Inventor: Jun Young SUNG, Yongin-si (KR)

(73) Assignee: HYUNDAI MOBIS CO., LTD., Seoul (KR)

(21) Appl. No.: 19/283,095

(22) Filed: Jul. 28, 2025

(30) Foreign Application Priority Data
Nov. 19, 2024 (KR) 10-2024-0164766

(51) Int. Cl. B60Q 1/34; B60Q 1/00; B60Q 1/50; H05B 47/16; H05B 47/17

(52) U.S. Cl. CPC B60Q 1/346; B60Q 1/0023; B60Q 1/507; H05B 47/16; H05B 47/17; B60Q 2900/50

(57) ABSTRACT

A lamp control system for a moving object includes a turn signal lamp to output a turn signal, a memory storing control information of the turn signal lamp according to driving information of the moving object, and a processor to control the turn signal lamp by using the control information stored in the memory and the driving information of the moving object.

### CROSS-REFERENCE TO RELATED APPLICATIONS

Pursuant to 35 U.S.C. § 119(a), this application claims the benefit of earlier filing dates and right of priority to Korean Application No. 10-2024-0164766, filed on Nov. 19, 2024, the contents of which are hereby incorporated by reference herein in their entirety.

### BACKGROUND

### Field

The present disclosure relates to a lamp control system, a lamp control method, and a vehicle, and more specifically, to a lamp control system, a lamp control method, and a vehicle configured to control lighting of a turn signal by using driving information.

### Discussion of the Related Art

For communication with a plurality of vehicles on a road, a turn signal is a required important function. Through the turn signal of vehicles including a preceding vehicle, left and right vehicles, and a rear vehicle, it notifies changes in a driving path in advance, allowing a driver to predict a driving path and drive safely.

A driver may probably experience the danger of a car suddenly cutting in or braking without a turn signal on.

As a driver drives for long periods of time or gain more driving experience, the driver tends to neglect to use turn signals, which may be dangerous to other vehicles and, in serious cases, may even lead to an accident.

Currently, there is a function that turns on a turn signal manually by a driver and automatically changes a driving path after recognizing a surrounding vehicle, but this still has inconvenience of the driver having to manually operate the function.

Accordingly, the present disclosure provides a method of controlling a turn signal lamp according to driving of a moving object.

### SUMMARY

The present disclosure proposes a lamp control system configured to control a turn signal lamp by using driving information of a moving object, a vehicle including the same, or a method therefor.

The present disclosure proposes a lamp control system configured to control a turn signal lamp according to control information of the turn signal lamp based on driving information and driving information of a moving object, a vehicle including the same, or a method therefor, in performing lamp control.

The object of the present disclosure is not limited to the object described above. Other objects not described above may be understood by those skilled in the art from the description of the present disclosure below.

According to an embodiment of the present disclosure, a lamp control system for a moving object is proposed and includes a turn signal lamp configured to output a turn signal, a memory configured to store control information of the turn signal lamp based on driving information of the moving object, and a processor configured to control the turn signal lamp according to the control information stored in the memory and the driving information of the moving object.

Additionally or alternatively, the processor may be configured to output the turn signal lamp differently depending on whether the driving information indicates a lane change or lane departure and whether the driving information indicates a machine driving, an autonomous driving, or driving by a driver.

Additionally or alternatively, the processor may be configured to control the turn signal lamp to be turned on according to a first lighting mode when the driving information indicates the machine driving or the autonomous driving, and to control the turn signal lamp to be turned on according to a second lighting mode when the driving information indicates driving by a driver.

Additionally or alternatively, the processor may be configured to control the lighting speed and lighting cycle of the turn signal lamp differently depending on a heading angle of the moving object indicated by the driving information.

Additionally or alternatively, the processor may be configured to control one of the lighting speed and the lighting cycle of the turn signal lamp according to the heading angle of the moving object when the driving information indicates driving by a driver, and to control the other one of the lighting speed and the lighting cycle of the turn signal lamp according to the heading angle of the moving object when the driving information indicates driving by the driver.

Additionally or alternatively, the lighting speed may be increased or the lighting cycle may be reduced decreased in accordance with an as increase in the heading angle of the moving object increases.

Additionally or alternatively, the processor may be configured to control the lighting speed and lighting cycle of the turn signal lamp differently depending on a distance between a next lane and the moving object in a direction of lane change or lane departure indicated by the driving information.

Additionally or alternatively, the processor may be configured to control one of the lighting speed and the lighting period of the turn signal lamp according to the distance between the moving object and the next lane in the direction of lane change or lane departure of the moving object, based on the driving information indicates machine driving or autonomous driving, and to control the other one of the lighting speed and the lighting period of the turn signal lamp according to the distance between the moving object and the next lane in the direction of lane change or lane departure of the moving object, based on the driving information indicates driving by the driver.

Additionally or alternatively, the lighting speed may be increased or the lighting cycle may be reduced decreased as a distance between a next lane and the moving object is reduced in a direction of lane change or lane departure of the moving object becomes shorter.

Additionally or alternatively, the first lighting mode may include a mode in which the turn signal lamp is sequentially lighted, and the second lighting mode includes a mode in which the turn signal lamp is lighted simultaneously.

According to another embodiment of the present disclosure, a lamp control method for a moving object is proposed, is performed by a lamp control system including a turn signal lamp configured to output a turn signal and includes obtaining driving information of the moving object, and controlling the turn signal lamp by using control information of the turn signal lamp according to the driving information of the moving object.

Additionally or alternatively, the lamp control method may include outputting the turn signal lamp differently depending on whether the driving information indicates a lane change or lane departure and whether the driving information indicates a machine driving, an autonomous driving, or driving by a driver.

Additionally or alternatively, the lamp control method may include controlling the turn signal lamp to be turned on according to a first lighting mode when the driving information indicates the machine driving or the autonomous driving and controlling the turn signal lamp to be turned on according to a second lighting mode when the driving information indicates driving by a driver.

Additionally or alternatively, the lamp control method may include controlling the lighting speed and lighting cycle of the turn signal lamp differently depending on a heading angle of the moving object indicated by the driving information.

Additionally or alternatively, the lamp control method may include based on the driving information indicating the machine driving or the autonomous driving, controlling one of the lighting speed and the lighting cycle of the turn signal lamp depending on a heading angle of the moving object, and based on the driving information indicating the driving by the driver, controlling the other one of the lighting speed and the lighting cycle of the turn signal lamp depending on the heading angle of the moving object.

Additionally or alternatively, the lighting speed may be increased or the lighting cycle may be decreased in accordance with an increase in the heading angle of the moving object.

Additionally or alternatively, the lamp control method may include controlling the lighting speed and lighting cycle of the turn signal lamp differently depending on a distance between a next lane and the moving object in a direction of lane change or lane departure indicated by the driving information.

Additionally or alternatively, the lamp control method may include based on the driving information indicating the machine driving or the autonomous driving, controlling one of the lighting speed and the lighting cycle of the turn signal lamp depending on a distance between a next lane and the moving object in a lane change direction or lane departure direction of the moving object, and based on the driving information indicating the driving by the driver, controlling the other one of the lighting speed and the lighting cycle of the turn signal lamp depending on the distance between the next lane and the moving object in the lane change direction or lane departure direction of the moving object.

Additionally or alternatively, the first lighting mode may include a mode in which the turn signal lamp is sequentially lighted, and the second lighting mode includes a mode in which the turn signal lamp is lighted simultaneously.

According to another embodiment of the present disclosure, a moving object is proposed and includes a lamp control system including a turn signal lamp configured to output a turn signal, a memory configured to store control information of the turn signal lamp based on driving information of the moving object, and a processor configured to control the turn signal lamp according to the control information stored in the memory and the driving information of the moving object.

The solution of the present disclosure is a part of the embodiments of the present disclosure. In addition to the solutions to the object, various solutions may be derived and understood based on a detailed description of the present disclosure described below.

### BRIEF DESCRIPTION OF THE DRAWINGS

The present disclosure will become more fully understood from the detailed description given herein below and the accompanying drawings, which are given by illustration only, and thus are not limitative of the present disclosure.

FIG. 1 is an overall block diagram of an autonomous driving control system to which an autonomous driving apparatus according to any one of embodiments of the present disclosure is applicable.

FIG. 2 is a diagram illustrating an example in which an autonomous driving apparatus according to any one of embodiments of the present disclosure is applied to a vehicle.

FIG. 3 illustrates a block diagram of a lamp control system according to the present disclosure.

FIG. 4 illustrates data collected and analyzed based on position information regarding a usage history of specific beam patterns of a plurality of moving objects according to the present disclosure.

FIGS. 5, 6, 7, 8, 9, and 10 illustrate a flowchart of a turn signal lamp control method according to the present disclosure.

FIG. 11 illustrates an example of a first lighting mode according to the present disclosure.

FIG. 12 illustrates an example of a first lighting mode according to the present disclosure.

### DETAILED DESCRIPTION

Hereinafter, embodiments of the present disclosure will be described in detail with reference to the accompanying drawings so that the present disclosure may be easily realized by those skilled in the art. However, the present disclosure may be achieved in various different forms and is not limited to the embodiments described herein. In the drawings, parts that are not related to a description of the present disclosure are omitted to clearly explain the present disclosure and similar reference numbers will be used throughout this specification to refer to similar parts.

In the specification, when a part “includes” an element, it means that the part may further include another element rather than excluding another element unless otherwise mentioned.

In addition, in the specification, “occupant”, “passenger”, “driver”, “user”, etc. are mentioned for description of the present disclosure, and may be used interchangeably therewith.

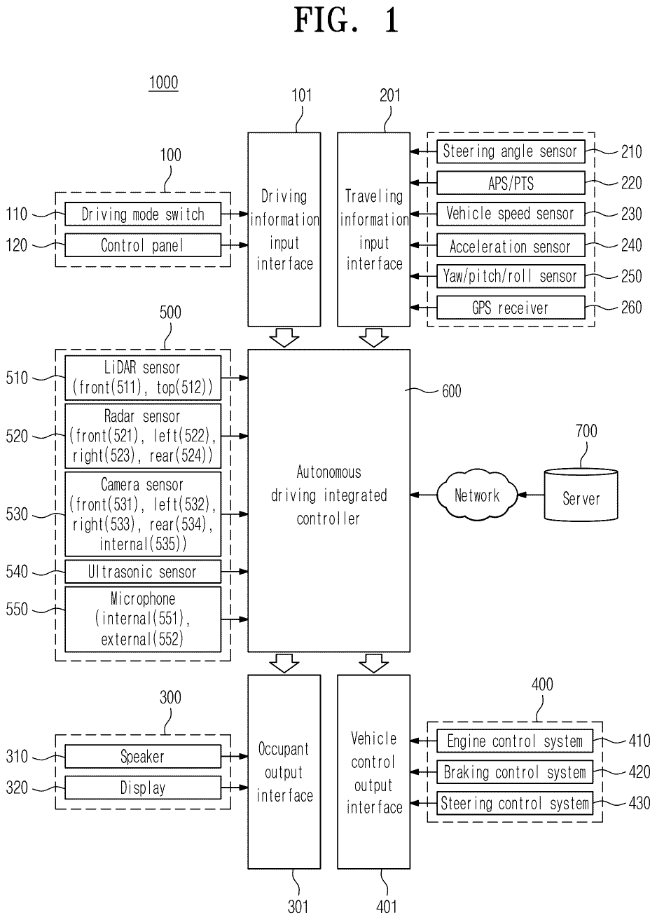

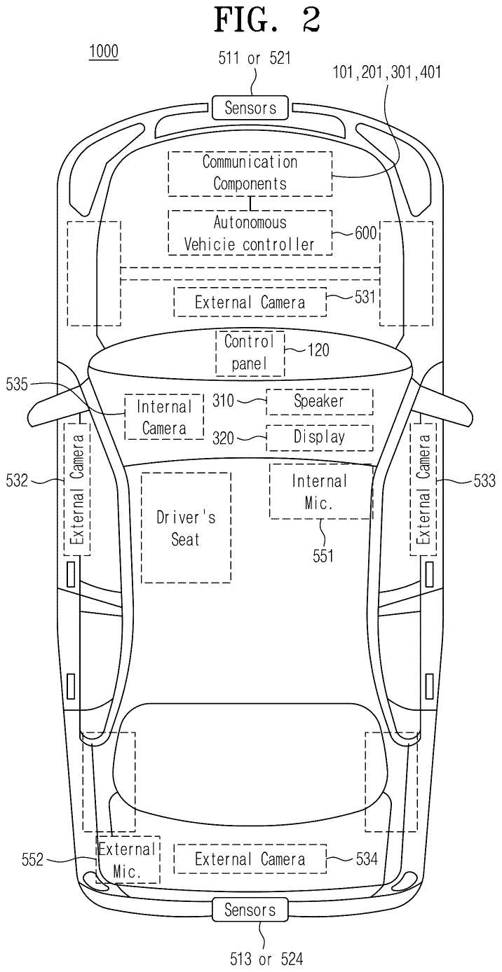

FIG. 1 is an overall block diagram of an autonomous driving control system to which an autonomous driving apparatus according to any one of embodiments of the present disclosure is applicable. FIG. 2 is a diagram illustrating an example in which an autonomous driving apparatus according to any one of embodiments of the present disclosure is applied to a vehicle.

First, a structure and function of an autonomous driving control system (e.g., an autonomous driving vehicle) to which an autonomous driving apparatus according to the present embodiments is applicable will be described with reference to FIGS. 1 and 2.

As illustrated in FIG. 1, an autonomous driving vehicle 1000 may be implemented based on an autonomous driving integrated controller 600 that transmits and receives data necessary for autonomous driving control of a vehicle through a driving information input interface 101, a traveling information input interface 201, an occupant output interface 301, and a vehicle control output interface 401. However, the autonomous driving integrated controller 600 may also be referred to herein as a controller, a processor, or, simply, a controller.

The autonomous driving integrated controller 600 may obtain, through the driving information input interface 101, driving information based on manipulation of an occupant for a user input unit 100 in an autonomous driving mode or manual driving mode of a vehicle. As illustrated in FIG. 1, the user input unit 100 may include a driving mode switch 110 and a control panel 120 (e.g., a navigation terminal mounted on the vehicle or a smartphone or tablet computer owned by the occupant). Accordingly, driving information may include driving mode information and navigation information of a vehicle.

For example, a driving mode (i.e., an autonomous driving mode/manual driving mode or a sports mode/eco mode/safety mode/normal mode) of the vehicle determined by manipulation of the occupant for the driving mode switch 110 may be transmitted to the autonomous driving integrated controller 600 through the driving information input interface 101 as the driving information.

Furthermore, navigation information, such as the destination of the occupant input through the control panel 120 and a path up to the destination (e.g., the shortest path or preference path, selected by the occupant, among candidate paths up to the destination), may be transmitted to the autonomous driving integrated controller 600 through the driving information input interface 101 as the driving information.

The control panel 120 may be implemented as a touchscreen panel that provides a user interface (UI) through which the occupant inputs or modifies information for autonomous driving control of the vehicle. In this case, the driving mode switch 110 may be implemented as touch buttons on the control panel 120.

In addition, the autonomous driving integrated controller 600 may obtain traveling information indicative of a driving state of the vehicle through the traveling information input interface 201. The traveling information may include a steering angle formed when the occupant manipulates a steering wheel, an accelerator pedal stroke or brake pedal stroke formed when the occupant depresses an accelerator pedal or brake pedal, and various types of information indicative of driving states and behaviors of the vehicle, such as a vehicle speed, acceleration, a yaw, a pitch, and a roll formed in the vehicle. The traveling information may be detected by a traveling information detection unit 200, including a steering angle sensor 210, an accelerator position sensor (APS)/pedal travel sensor (PTS) 220, a vehicle speed sensor 230, an acceleration sensor 240, and a yaw/pitch/roll sensor 250, as illustrated in FIG. 1.

Furthermore, the traveling information of the vehicle may include location information of the vehicle. The location information of the vehicle may be obtained through a global positioning system (GPS) receiver 260 applied to the vehicle. Such traveling information may be transmitted to the autonomous driving integrated controller 600 through the traveling information input interface 201 and may be used to control the driving of the vehicle in the autonomous driving mode or manual driving mode of the vehicle.

The autonomous driving integrated controller 600 may transmit driving state information provided to the occupant to an output unit 300 through the occupant output interface 301 in the autonomous driving mode or manual driving mode of the vehicle. That is, the autonomous driving integrated controller 600 transmits the driving state information of the vehicle to the output unit 300 so that the occupant may check the autonomous driving state or manual driving state of the vehicle based on the driving state information output through the output unit 300. The driving state information may include various types of information indicative of driving states of the vehicle, such as a current driving mode, transmission range, and speed of the vehicle.

If it is determined that it is necessary to warn a driver in the autonomous driving mode or manual driving mode of the vehicle along with the above driving state information, the autonomous driving integrated controller 600 transmits warning information to the output unit 300 through the occupant output interface 301 so that the output unit 300 may output a warning to the driver. In order to output such driving state information and warning information acoustically and visually, the output unit 300 may include a speaker 310 and a display 320 as illustrated in FIG. 1. In this case, the display 320 may be implemented as the same device as the control panel 120 or may be implemented as an independent device separated from the control panel 120.

Furthermore, the autonomous driving integrated controller 600 may transmit control information for driving control of the vehicle to a lower control system 400, applied to the vehicle, through the vehicle control output interface 401 in the autonomous driving mode or manual driving mode of the vehicle. As illustrated in FIG. 1, the lower control system 400 for driving control of the vehicle may include an engine control system 410, a braking control system 420, and a steering control system 430. The autonomous driving integrated controller 600 may transmit engine control information, braking control information, and steering control information, as the control information, to the respective lower control systems 410, 420, and 430 through the vehicle control output interface 401. Accordingly, the engine control system 410 may control the speed and acceleration of the vehicle by increasing or decreasing fuel supplied to an engine. The braking control system 420 may control the braking of the vehicle by controlling braking power of the vehicle. The steering control system 430 may control the steering of the vehicle through a steering device (e.g., motor driven power steering (MDPS) system) applied to the vehicle.

As described above, the autonomous driving integrated controller 600 according to the present embodiment may obtain the driving information based on manipulation of the driver and the traveling information indicative of the driving state of the vehicle through the driving information input interface 101 and the traveling information input interface 201, respectively, and transmit the driving state information and the warning information, generated based on an autonomous driving algorithm, to the output unit 300 through the occupant output interface 301. In addition, the autonomous driving integrated controller 600 may transmit the control information generated based on the autonomous driving algorithm to the lower control system 400 through the vehicle control output interface 401 so that driving control of the vehicle is performed.

In order to guarantee stable autonomous driving of the vehicle, it is necessary to continuously monitor the driving state of the vehicle by accurately measuring a driving environment of the vehicle and to control driving based on the measured driving environment. To this end, as illustrated in FIG. 1, the autonomous driving apparatus according to the present embodiment may include a sensor unit 500 for detecting a nearby object of the vehicle, such as a nearby vehicle, pedestrian, road, or fixed facility (e.g., a signal light, a signpost, a traffic sign, or a construction fence).

The sensor unit 500 may include one or more of a LIDAR sensor 510, a radar sensor 520, or a camera sensor 530, in order to detect a nearby object outside the vehicle, as illustrated in FIG. 1.

The LiDAR sensor 510 may transmit a laser signal to the periphery of the vehicle and detect a nearby object outside the vehicle by receiving a signal reflected and returning from a corresponding object. The LiDAR sensor 510 may detect a nearby object located within the ranges of a preset distance, a preset vertical field of view, and a preset horizontal field of view, which are predefined depending on specifications thereof. The LiDAR sensor 510 may include a front LiDAR sensor 511, a top LiDAR sensor 512, and a rear LiDAR sensor 513 installed at the front, top, and rear of the vehicle, respectively, but the installation location of each LiDAR sensor and the number of LiDAR sensors installed are not limited to a specific embodiment. A threshold for determining the validity of a laser signal reflected and returning from a corresponding object may be previously stored in a memory (not illustrated) of the autonomous driving integrated controller 600. The autonomous driving integrated controller 600 may determine a location (including a distance to a corresponding object), speed, and moving direction of the corresponding object using a method of measuring time taken for a laser signal, transmitted through the LiDAR sensor 510, to be reflected and returning from the corresponding object.

The radar sensor 520 may radiate electromagnetic waves around the vehicle and detect a nearby object outside the vehicle by receiving a signal reflected and returning from a corresponding object. The radar sensor 520 may detect a nearby object within the ranges of a preset distance, a preset vertical field of view, and a preset horizontal field of view, which are predefined depending on specifications thereof. The radar sensor 520 may include a front radar sensor 521, a left radar sensor 522, a right radar sensor 523, and a rear radar sensor 524 installed at the front, left, right, and rear of the vehicle, respectively, but the installation location of each radar sensor and the number of radar sensors installed are not limited to a specific embodiment. The autonomous driving integrated controller 600 may determine a location (including a distance to a corresponding object), speed, and moving direction of the corresponding object using a method of analyzing power of electromagnetic waves transmitted and received through the radar sensor 520.

The camera sensor 530 may detect a nearby object outside the vehicle by photographing the periphery of the vehicle and detect a nearby object within the ranges of a preset distance, a preset vertical field of view, and a preset horizontal field of view, which are predefined depending on specifications thereof.

The camera sensor 530 may include a front camera sensor 531, a left camera sensor 532, a right camera sensor 533, and a rear camera sensor 534 installed at the front, left, right, and rear of the vehicle, respectively, but the installation location of each camera sensor and the number of camera sensors installed are not limited to a specific embodiment. The autonomous driving integrated controller 600 may determine a location (including a distance to a corresponding object), speed, and moving direction of the corresponding object by applying predefined image processing to an image captured by the camera sensor 530.

In addition, an internal camera sensor 535 for capturing the inside of the vehicle may be mounted at a predetermined location (e.g., rear view mirror) within the vehicle. The autonomous driving integrated controller 600 may monitor a behavior and state of the occupant based on an image captured by the internal camera sensor 535 and output guidance or a warning to the occupant through the output unit 300.

As illustrated in FIG. 1, the sensor unit 500 may further include an ultrasonic sensor 540 in addition to the LiDAR sensor 510, the radar sensor 520, and the camera sensor 530 and further adopt various types of sensors for detecting a nearby object of the vehicle along with the sensors.

FIG. 2 illustrates an example in which, in order to aid in understanding the present embodiment, the front LiDAR sensor 511 or the front radar sensor 521 is installed at the front of the vehicle, the rear LiDAR sensor 513 or the rear radar sensor 524 is installed at the rear of the vehicle, and the front camera sensor 531, the left camera sensor 532, the right camera sensor 533, and the rear camera sensor 534 are installed at the front, left, right, and rear of the vehicle, respectively. However, as described above, the installation location of each sensor and the number of sensors installed are not limited to a specific embodiment.

Furthermore, in order to determine a state of the occupant within the vehicle, the sensor unit 500 may further include a bio sensor for detecting bio signals (e.g., heart rate, electrocardiogram, respiration, blood pressure, body temperature, electroencephalogram, photoplethysmography (or pulse wave), and blood sugar) of the occupant. The bio sensor may include a heart rate sensor, an electrocardiogram sensor, a respiration sensor, a blood pressure sensor, a body temperature sensor, an electroencephalogram sensor, a photoplethysmography sensor, and a blood sugar sensor.

Finally, the sensor unit 500 additionally includes a microphone 550 having an internal microphone 551 and an external microphone 552 used for different purposes.

The internal microphone 551 may be used, for example, to analyze the voice of the occupant in the autonomous driving vehicle 1000 based on AI or to immediately respond to a direct voice command of the occupant.

In contrast, the external microphone 552 may be used, for example, to appropriately respond to safe driving by analyzing various sounds generated from the outside of the autonomous driving vehicle 1000 using various analysis tools such as deep learning.

For reference, the symbols illustrated in FIG. 2 may perform the same or similar functions as those illustrated in FIG. 1. FIG. 2 illustrates in more detail a relative positional relationship of each component (based on the interior of the autonomous driving vehicle 1000) as compared with FIG. 1.

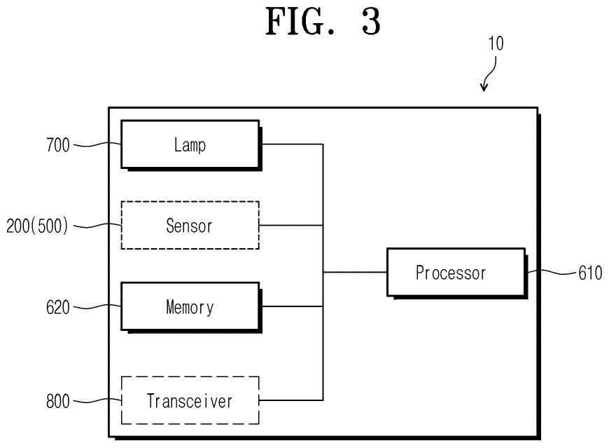

FIG. 3 illustrates a block diagram of a lamp control system according to the present disclosure.

A lamp control system 10 may include a lamp 700, a memory 620, and a processor 610. The lamp control system 10 may be included in a moving object 1000 and may be mounted or installed in the moving object 1000. In this specification, the moving object means an object that has mobility as a transportation, and may include, for example, a vehicle, a drone, and a robot.

The lamp 700 is a type of output unit that irradiates a beam in a front direction of a moving object according to a beam pattern and may be formed in a pair. In more detail, the lamp 700 may include a pair of headlamps on a left front and right front based on the moving object (or vehicle). In general, a headlamp or a headlight may include a low beam, a high beam, a turn signal, a daytime driving light, and a side light.

The lamp 700 may include a turn signal lamp, referred to as a turn signal. The turn signal lamp may output a turn signal to notify rear or oncoming vehicles, pedestrians, or the like that a moving object is about to change lanes or enter or exit a lane.

The memory 620 may store control information of the turn signal lamp according to driving information of the moving object 1000. Here, control information of the turn signal lamp according to driving information may be linked with location information. That is, the driving information may include position-based driving information. Additionally or alternatively, the memory 620 may store data object by analyzing and refining the control information of the turn signal lamp according to the driving information. Here, the driving information may include information about a frequency of lane changes on separate road segments for a plurality of moving objects, or a frequency of use of a turn signal lamp on separate road segments (or a frequency of manipulation of a multi-function switch to activate the turn signal lamp). That is, the driving information may include information obtained by collecting, digitizing, and processing lane change information of moving objects passing through a corresponding road segment on the separate road segment or information of use of the turn signal lamp.

Prior to this, the lamp control system 10 may be configured to receive the position-based driving information from a server.

The position-based driving information may include information linked to position information that may infer lane change information of a plurality of moving objects. That is, the server may collect and store, analyze, process, or manage navigation information of moving objects driving on separate road segments or GPS information of moving objects related thereto, information related to an advanced driver assistance system (ADAS) of moving objects, or output interface information for vehicle control of moving objects.

The navigation information of moving objects or GPS information of moving objects related thereto may indicate position information that may be used to determine whether a moving object changes lanes. Accordingly, the server may analyze the navigation information of the moving objects or the GPS information of the moving objects to extract lane change information or frequency of lane changes on separate road segments. The server may digitize the lane change information or the frequency of lane changes and indicate the same as a refined number.

For example, the following data may be obtained.

TABLE 1

| | lane change frequency (relative |
|---|---|
| Road segment | index) |
| RD1 | 90 |
| RD2 | 97 |
| RD3 | 7 |
| RD4 | 15 |
| . . . | . . . |

As another piece of information, ADAS-related information of moving objects may indicate driving control information (such as acceleration, steering or braking) for the moving object to determine whether the moving object changes lanes, and the ADAS-related information may be linked with position information. Therefore, the server may analyze the ADAS-related information of moving objects to extract driving control information (such as acceleration, steering, or braking) for separate road segments.

Accordingly, the server may extract the lane change information or frequency of lane changes from the driving control information. The server may digitize the lane change information or the frequency of lane changes and indicate the same as a refined number.

As another piece of information, output interface information for controlling the moving objects (or vehicles) of the moving objects may indicate engine control information, braking control information, and steering control information of the moving objects that may determine whether the moving objects change lanes, and the output interface information for controlling the moving objects (or vehicles) may be linked with position information. When a moving object obtains propulsion by using an electric motor, it is obvious that motor control information is used instead of engine control information.

Accordingly, the server may analyze output interface information for moving object control of moving objects to extract engine control information, braking control information, and steering control information for separate road segments.

Accordingly, the server may extract the lane change information or the frequency of lane changes from the engine control information, braking control information, and steering control information. The server may digitize the lane change information or the frequency of lane changes and indicate the same as a refined number.

The position-based driving information may include data linked to an output control signal of a manipulator (e.g., a multi-function switch) for lighting a turn signal lamp of a plurality of moving objects and data linked with the position information of the moving object.

That is, the server may collect and store or manage an output control signal for a manipulator such as a multi-function switch for lighting the turn signal lamp of a plurality of moving objects and position information at a time when the output control signal obtained by a position information obtaining device such as a navigation (or GPS receiver) is detected.

The server may analyze input control signals for the manipulator such as a multi-function switch for lighting the turn signal lamp or position information of moving objects related thereto to extract usage information of the turn signal lamp or a frequency of use of the turn signal lamp on separate road segments. The server may digitize the usage information of the turn signal lamp or the frequency of use of the turn signal lamp and indicate the same as a refined number.

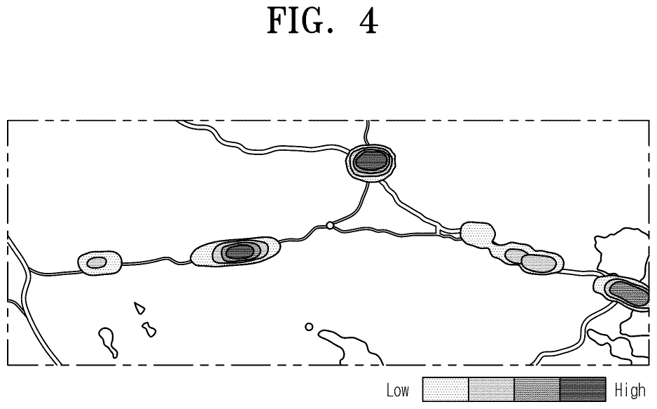

An example of big data on a position-based frequency of lane changes or use of the turn signal lamp according to the present disclosure is illustrated in FIG. 4.

As seen from FIG. 4, a frequency of lane changes or a frequency of use (lighting) of the turn signal lamp is indicated by hatching on a map. The information shown in FIG. 4 is indicated by collecting, analyzing, and refining any one of the frequency of lane changes of a plurality of moving objects or the frequency of use of a turn signal lamp.

A region (position) in which moving objects perform lane changes or use a turn signal lamp a lot (or frequently) may be understood as a region in which lane changes or lighting of the turn signal lamp need to be turned on due to a road condition or traffic volume. The present disclosure proposes control of a turn signal lamp corresponding to lane changes or lighting of the turn signal lamp at a position at which lane changes or lighting of the turn signal lamp occur frequently even if a driver or user of a moving object does not separately operate lighting or control of the turn signal lamp.

The processor 610 may obtain position information of the moving object 1000. The position information of the moving object 1000 may be obtained by a sensor 200.

The processor 610 may be configured to control the lamp 700 by using the processor 610 of the moving object 1000 and the position-based driving information stored in the memory 620. In more detail, the processor 610 may be configured to control a turn signal lamp irradiated by the lamp 700.

The processor 610 may be configured to turn on the turn signal lamp when the frequency of lane changes of driving information corresponding to the position information of the moving object 1000 or the frequency of use of a turn signal lamp, indicated by the position-based driving information stored in the memory 620, exceeds a preset reference.

Here, the preset reference may be expressed as relative numbers representing, for example, a frequency of lane changes for each separate road segment or a frequency of lighting the turn signal lamp. As such, the processor 610 may be configured to strengthen an optical width of a beam pattern when the frequency of lane changes of a road segment on which the moving object 1000 is currently positioned or a frequency of lighting of the turn signal lamp exceeds a preset reference.

The processor 610 may be configured not to turn on the turn signal lamp when the frequency of lane changes of the position-based driving information corresponding to position information of the moving object 1000 or the frequency of use of the turn signal lamp, indicated by the driving information stored in the memory 620, is lower than a present reference.

The processor 610 may be configured not to use the position-based driving information illustrated in FIG. 4, to store control information of the turn signal lamp according to the driving information in the memory 620 of the lamp control system 10 of a moving object, and to control the turn signal lamp by using the control information.

Here, the driving information may include information on lane change or lane departure of the moving object, machine driving or autonomous driving or manual driving (by a driver), or (in case of lane change or lane departure) distance to a next lane in a direction of lane change or lane departure.

The control information of the turn signal lamp according to driving information may be defined as follows, but the present disclosure is not limited thereto.

The following table shows the control information for the turn signal lamp according to driving information used in the case of lane change or lane departure of a moving object.

TABLE 2

| | Whether machine | | |
|---|---|---|---|
| | (autonomous) driving | | |
| Heading angle of moving | or manual (driver) | Mode of lighting turn | Lighting speed or |
| object | driving | signal lamp | lighting cycle |
| Exceeding first reference | Machine | First lighting mode | First reference speed |
| angle | (autonomous) driving | | |
| Exceeding second | Machine | First lighting mode | Second reference speed |
| reference angle and less | (autonomous) driving | | |
| than or equal to first | | | |
| reference angle | | | |
| Exceeding third | Machine | First lighting mode | Third reference speed |
| reference angle and less | (autonomous) driving | | |
| than or equal to second | | | |
| reference angle | | | |
| . . . | . . . | . . . | . . . |
| Exceeding Nth reference | Machine | First lighting mode | Nth reference speed |
| angle and less than or | (autonomous) driving | | |
| equal to (N − 1)th | | | |
| reference angle | | | |
| Exceeding first reference | Manual (driver) | Second lighting mode | First reference cycle |
| angle | driving | | |
| Exceeding second | Manual (driver) | Second lighting mode | Second reference cycle |
| reference angle and less | driving | | |
| than or equal to first | | | |
| reference angle | | | |
| Exceeding third | Manual (driver) | Second lighting mode | Third reference cycle |
| reference angle and less | driving | | |
| than or equal to second | | | |
| reference angle | | | |
| . . . | . . . | . . . | . . . |
| Exceeding Nth reference | Manual (driver) | Second lighting mode | Nth reference cycle |
| angle and less than or | driving | | |
| equal to (N − 1)th | | | |
| reference angle | | | |

TABLE 3

| | Whether machine | | |
|---|---|---|---|
| Distance to next lane in | (autonomous) driving | | |
| direction of lane change | or manual (driver) | Mode of lighting turn | Lighting speed or |
| or lane departure | driving | signal lamp | lighting cycle |
| Less than first reference | Machine | First lighting mode | First reference speed |
| distance | (autonomous) driving | | |
| More than or equal to | Machine | First lighting mode | Second reference speed |
| first reference distance | (autonomous) driving | | |
| and less than second | | | |
| reference distance | | | |
| More than or equal to | Machine | First lighting mode | Third reference speed |
| second reference | (autonomous) driving | | |
| distance and less than | | | |
| third reference distance | | | |
| . . . | . . . | . . . | . . . |
| More than or equal to | Machine | First lighting mode | Nth reference speed |
| (N − 1)th reference | (autonomous) driving | | |
| distance and less than | | | |
| Nth reference distance | | | |
| Less than first reference | Manual (driver) | Second lighting mode | First reference cycle |
| distance | driving | | |
| More than or equal to | Manual (driver) | Second lighting mode | Second reference cycle |
| first reference distance | driving | | |
| and less than second | | | |
| reference distance | | | |
| More than or equal to | Manual (driver) | Second lighting mode | Third reference cycle |
| second reference | driving | | |
| distance and less than | | | |
| third reference distance | | | |
| . . . | . . . | . . . | . . . |
| More than or equal to | Manual (driver) | Second lighting mode | Nth reference cycle |
| (N − 1)th reference | driving | | |
| distance and less than | | | |
| Nth reference distance | | | |

Here, first reference angle>second reference angle>third reference angle> . . . >Nth reference angle.

First reference distance<second reference distance<third reference distance< . . . <Nth reference distance.

First reference speed>second reference speed>third reference speed> . . . >Nth reference speed.

First reference cycle<second reference cycle<third reference cycle< . . . <Nth reference cycle.

The control information of the turn signal lamp according to the driving information in Tables 2 and 3 above corresponds to an example. The processor 610 may be configured to control the turn signal lamp by using control information of the turn signal lamp according to driving information stored in the memory 620.

In more detail, the processor 610 may be configured to output the turn signal lamp differently depending on whether the driving information indicates a lane change or lane departure and whether the driving information is machine driving, autonomous driving, or driving by a driver.

The processor 610 may be configured to control the turn signal lamp to be turned on according to either the first lighting mode or the second lighting mode when the driving information indicates the machine driving or the autonomous driving, and to control the turn signal lamp to be turned on according to the remaining of the first lighting mode or the second lighting mode when the driving information indicates driving by a driver.

The processor 610 may be configured to control the lighting speed or lighting cycle of the turn signal lamp differently depending on a heading angle of the moving object indicated by the driving information.

The processor 610 may be configured to control one of the lighting speed or lighting cycle of the turn signal lamp according to the heading angle of the moving object when the driving information indicates driving by a driver, and to control the remaining one of the lighting speed or lighting cycle of the turn signal lamp according to the heading angle of the moving object when the driving information indicates driving by the driver. Here, the processor 610 may be configured to increase the lighting speed or reduce the lighting cycle as the heading angle of the moving object increases.

The processor 610 may be configured to control the lighting speed or lighting cycle of the turn signal lamp differently depending on a distance between a next lane and the moving object in a direction of lane change or lane departure indicated by the driving information.

The processor 610 may be configured to control one of the lighting speed or lighting period of the turn signal lamp according to the distance between the moving object and the next lane in the direction of lane change or lane departure of the moving object, as the driving information indicates machine driving or autonomous driving, and to control the remaining one of the lighting speed or lighting period of the turn signal lamp according to the distance between the moving object and the next lane in the direction of lane change or lane departure of the moving object, as the driving information indicates driving by the driver. Here, the processor 610 may be configured to increase the lighting speed or reduce the lighting cycle as the distance between the next lane and the moving object is reduced in the direction of lane change or lane departure of the moving object.

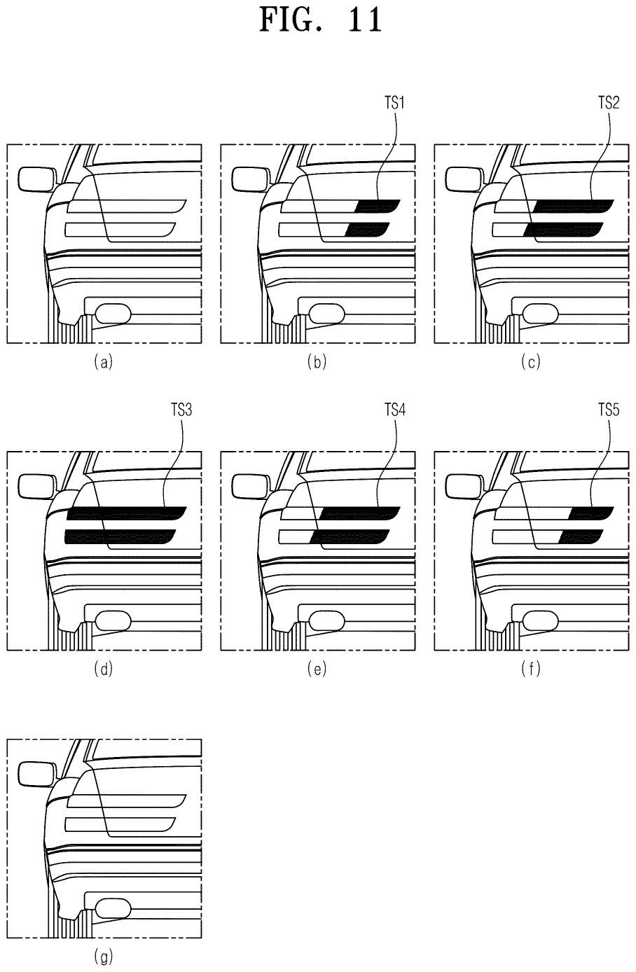

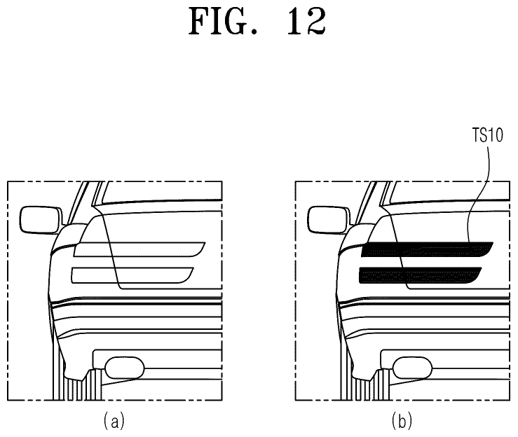

The first lighting mode includes a method in which the turn signal lamps are sequentially lighted, and the sequential lighting mode is illustrated in FIG. 11. The second lighting mode includes a method in which the turn signal lamps are lighted simultaneously, and the simultaneous lighting mode is illustrated in FIG. 12.

The lamp control system 10 may further include a sensor 200 or 500. The sensor may include sensors 210, 220, 230, 240, 250, and 260 configured to obtain information related to driving of the moving object or sensors 510, 520, 530, and 540 configured to obtain surrounding information of the moving object. The current position information of the moving object 1000 may be obtained through the sensor. The position information of surrounding vehicles, such as a preceding vehicle or oncoming vehicle of the moving object 1000, may be obtained through the sensor.

The lamp control system 10 may further include a transceiver 800. The transceiver 800 may be configured to receive position-based driving information from a server. The transceiver 800 may be configured to transmit, to the server, the position-based driving information of the moving object 1000 on which the lamp control system 10 is mounted or installed.

The transceiver 800 may be configured to receive, from the server, control information of the turn signal lamp according to driving information.

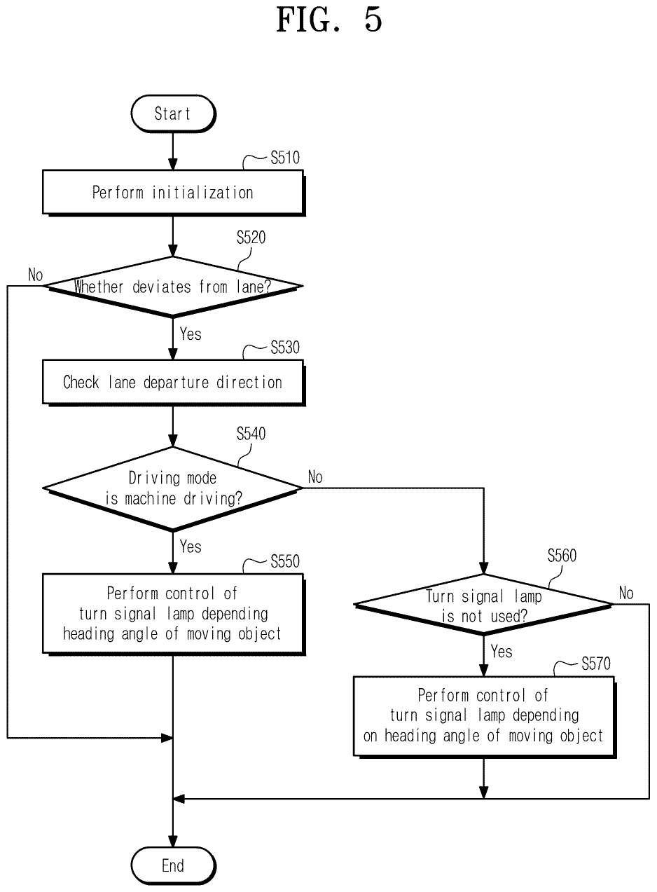

FIG. 5 illustrates a flowchart of a lamp control method according to the present disclosure. The illustrated lamp control method may be performed by the lamp control system 10 or the moving object 1000 including the lamp control system 10. For simplicity of explanation, the method illustrated below will be described as being performed by the lamp control system 10.

The lamp control system 10 may be configured to perform initialization (S510).

Initialization may include a procedure to check the system to ensure that the lamp control system operates properly.

The lamp control system 10 may determine whether the moving object 1000 changes lanes or deviates from the lane (S520).

Lane change or lane departure information of the moving object 1000 may be obtained by the sensor 200.

When the moving object 1000 does not change lanes or depart from a lane, the method is terminated.

The lamp control system 10 may check a lane change direction or lane departure direction (S530). The lamp control system 10 may determine whether a driving direction of the moving object 1000 is left or right.

The lamp control system 10 may check whether a driving mode of the moving object 1000 is a machine (autonomous) driving mode (S540). To this end, the lamp control system 10 may check the driving mode of the moving object 1000 through an autonomous driving integrated controller 600 or the processor 610.

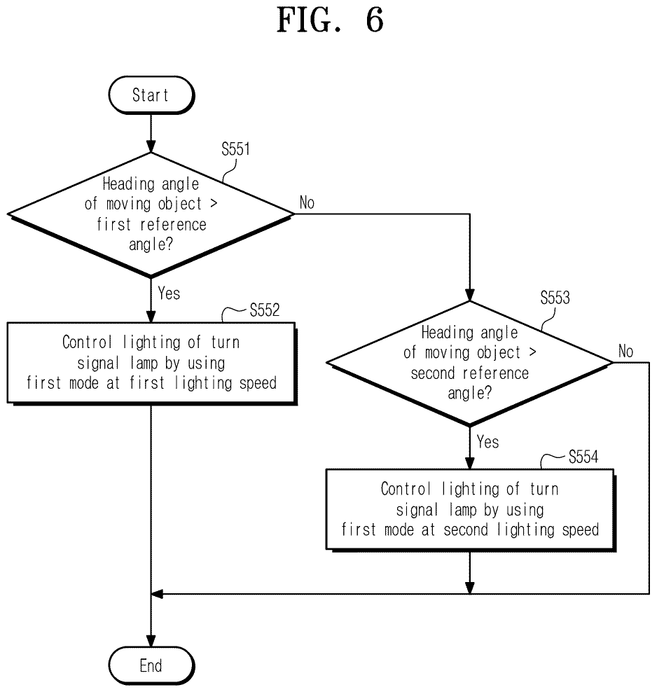

The driving mode of the moving object 1000 is a machine (autonomous) driving mode, and thus the lamp control system 10 may control the turn signal lamp according to the heading angle of the moving object (S550). This will be described below with reference to FIG. 6.

The driving mode of the moving object 1000 is not a machine (autonomous) driving mode, and thus the lamp control system 10 may check whether the turn signal lamp of the moving object 1000 is used (S560).

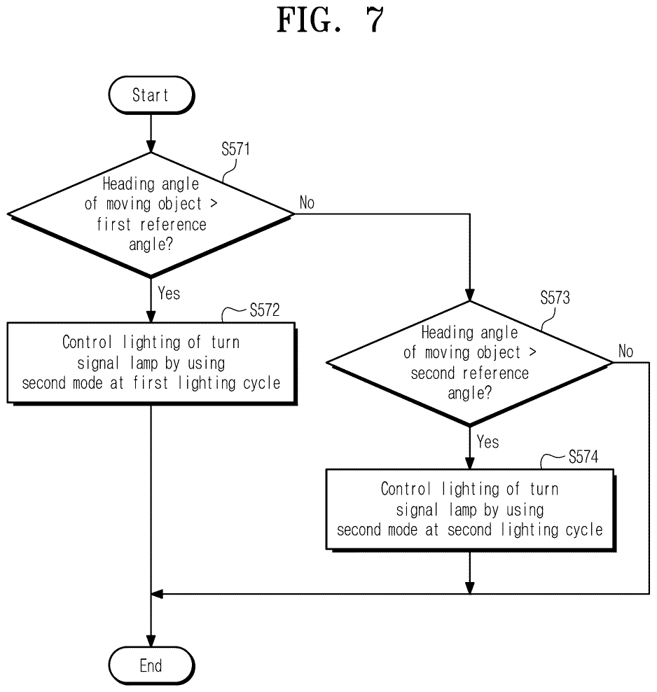

The turn signal lamp of the moving object 1000 is not used, and thus the lamp control system 10 may control the turn signal lamp according to the heading angle of the moving object (S570). This will be described below with reference to FIG. 7.

When the turn signal lamp of the moving object 1000 is used, the present method may be terminated. However, the present method may be performed regardless of whether the turn signal lamp of the moving object 1000 is not used (S560). That is, even if the turn signal lamp of the moving object 1000 is used, the lamp control system 10 may perform control of the turn signal lamp according to a heading angle (S570). In other words, the method may be implemented with S560 of FIG. 5 omitted.

S520 and S530 of FIG. 5 are information that may be detected by the sensor 200 of the moving object, and the information may be explained as being obtained by the lamp control system 10 from the sensor or the like. Alternatively, instead of whether to change lanes or depart from a lane, a condition for initiating control of a turn signal lamp based on refined data obtained by analyzing control information of the turn signal lamp according to the driving information described above may be used. That is, as illustrated in FIG. 4, based on position information about the frequency of lane changes or the frequency of use of a turn signal lamp, it is possible to modify the process below S530 to be performed when a current position of the moving object is higher than a preset reference for the frequency of lane changes or the frequency of use of a turn signal lamp.

FIG. 6 is a flowchart of control of a turn signal lamp depending on a heading angle when a driving mode is machine (autonomous) driving according to the present disclosure, and FIG. 7 illustrates a flowchart of control of a turn signal lamp depending on a heading angle when a driving mode is manual (driver) driving according to the present disclosure.

FIG. 6 is described first.

The lamp control system 10 may check whether a heading angle of the moving object 1000 is greater than a first reference angle (S551).

As the heading angle of the moving object 1000 is greater than the first reference angle, the lamp control system 10 may be configured to control lighting of the turn signal lamp by using a first method at a first lighting speed (S552).

The heading angle of the moving object 1000 is not greater than the first reference angle, and thus the lamp control system 10 may check whether the heading angle of the moving object 1000 is greater than a second reference angle (S553). As described above, the first reference angle may be set to be greater than the second reference angle.

As the heading angle of the moving object 1000 is greater than the second reference angle, the lamp control system 10 may be configured to control lighting of the turn signal lamp by using the first method at a second lighting speed (S554). As described above, the second lighting speed may be set to be less than the first lighting speed.

As the heading angle of the moving object 1000 is not greater than the second reference angle, the method may be terminated.

However, as described with reference to Table 2 and Table 3, a plurality (N) of reference angles, lighting speeds, and the like may be used to control the turn signal lamp according to the present disclosure. If N is 3 or greater, when the heading angle of the moving object 1000 is not greater than the second reference angle, an additional operation may be added in which the heading angle of the moving object 1000 is compared with the third reference angle. In this case, as the heading angle of the moving object 1000 is greater than the third reference angle, the lamp control system 10 may be configured to control lighting of the turn signal lamp by using the first method at a third lighting speed. In this case, the third lighting speed may be set to be less than the second lighting speed. In this way, the procedure for comparing the heading angle of the moving object with the reference angle and a corresponding lighting control, and the like may be performed N times.

FIG. 7 is described. FIG. 7 is performed, unlike FIG. 6, when a driving mode of the moving object 1000 is manual (driver) mode.

The lamp control system 10 may check whether a heading angle of the moving object 1000 is greater than a first reference angle (S571).

As the heading angle of the moving object 1000 is greater than the first reference angle, the lamp control system 10 may be configured to control lighting of the turn signal lamp by using a second method at a first lighting cycle (S572).

The heading angle of the moving object 1000 is not greater than the first reference angle, and thus the lamp control system 10 may check whether the heading angle of the moving object 1000 is greater than a second reference angle (S573). As described above, the first reference angle may be set to be greater than the second reference angle.

As the heading angle of the moving object 1000 is greater than the second reference angle, the lamp control system 10 may be configured to control lighting of the turn signal lamp by using the second method at a second lighting cycle (S574). As described above, the second lighting cycle may be set to be greater than the first lighting cycle. That is, a lighting cycle of the turn signal lamp may be set to be reduced as the heading angle increases.

As the heading angle of the moving object 1000 is not greater than the second reference angle, the method may be terminated.

However, as described with reference to Table 2 and Table 3, a plurality (N) of reference angles, lighting cycles, and the like may be used to control the turn signal lamp according to the present disclosure. If N is 3 or greater, when the heading angle of the moving object 1000 is not greater than the second reference angle, an additional operation may be added in which the heading angle of the moving object 1000 is compared with the third reference angle. In this case, as the heading angle of the moving object 1000 is greater than the third reference angle, the lamp control system 10 may be configured to control lighting of the turn signal lamp by using the second method at a third lighting cycle. In this case, the third lighting cycle may be set to be greater than the second lighting cycle. In this way, the procedure for comparing the heading angle of the moving object with the reference angle and a corresponding lighting control, and the like may be performed N times.

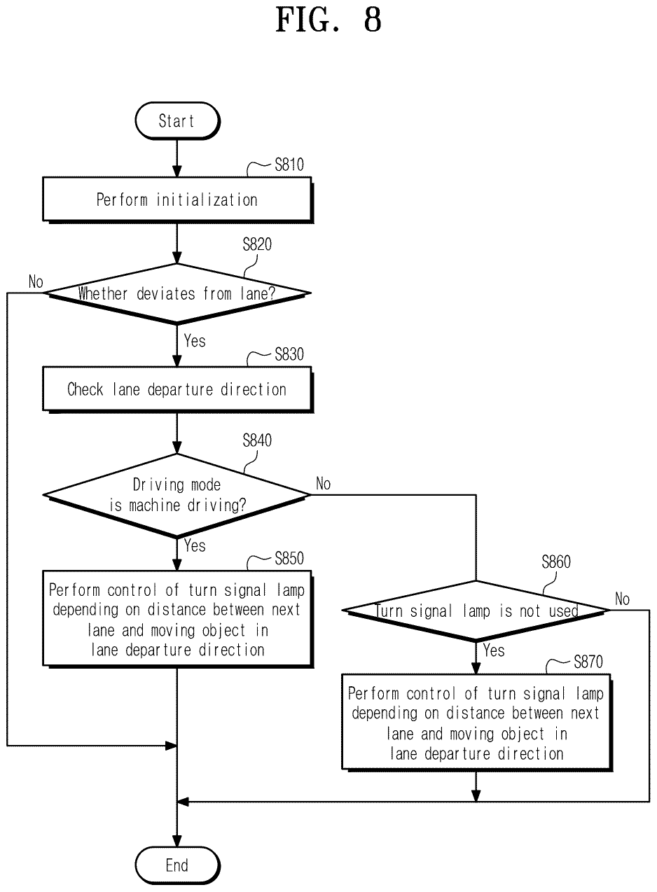

FIG. 8 illustrates a flowchart of a lamp control method according to the present disclosure. The illustrated lamp control method may be performed by the lamp control system 10 or the moving object 1000 including the lamp control system 10. For simplicity of explanation, the method illustrated below will be described as being performed by the lamp control system 10.

The lamp control system 10 may be configured to perform initialization (S810).

Initialization may include a procedure to check the system to ensure that the lamp control system operates properly.

The lamp control system 10 may determine whether the moving object 1000 changes lanes or deviates from the lane (S820).

Lane change or lane departure information of the moving object 1000 may be obtained by the sensor 200.

When the moving object 1000 does not change lanes or depart from a lane, the method is terminated.

The lamp control system 10 may check a lane change direction or lane departure direction (S830). The lamp control system 10 may determine whether a driving direction of the moving object 1000 is left or right.

The lamp control system 10 may check whether a driving mode of the moving object 1000 is a machine (autonomous) driving mode (S840). To this end, the lamp control system 10 may check the driving mode of the moving object 1000 through an autonomous driving integrated controller 600 or the processor 610.

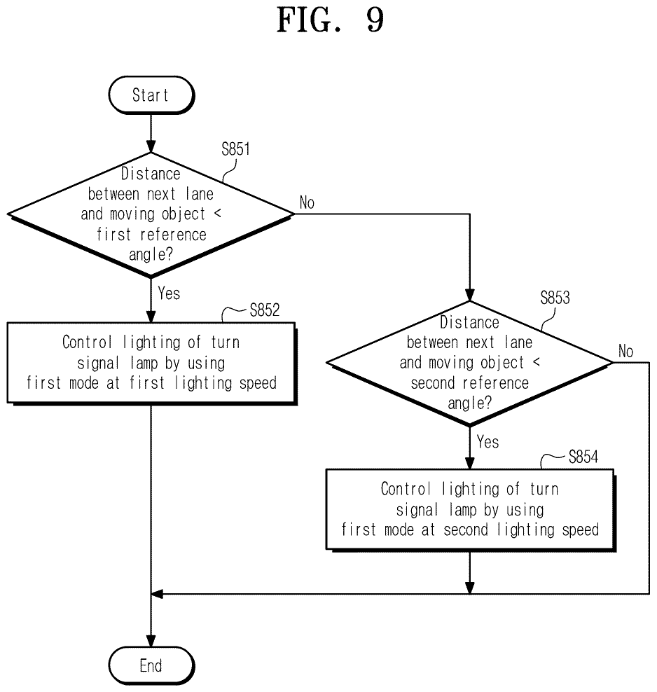

The driving mode of the moving object 1000 is a machine (autonomous) driving mode, the lamp control system 10 may control the turn signal lamp according to a distance of the moving object from a next lane in the lane change direction or lane departure direction of the moving object 1000 (S850). This will be described below with reference to FIG. 9.

The driving mode of the moving object 1000 is not a machine (autonomous) driving mode, and thus the lamp control system 10 may check whether the turn signal lamp of the moving object 1000 is used (S860).

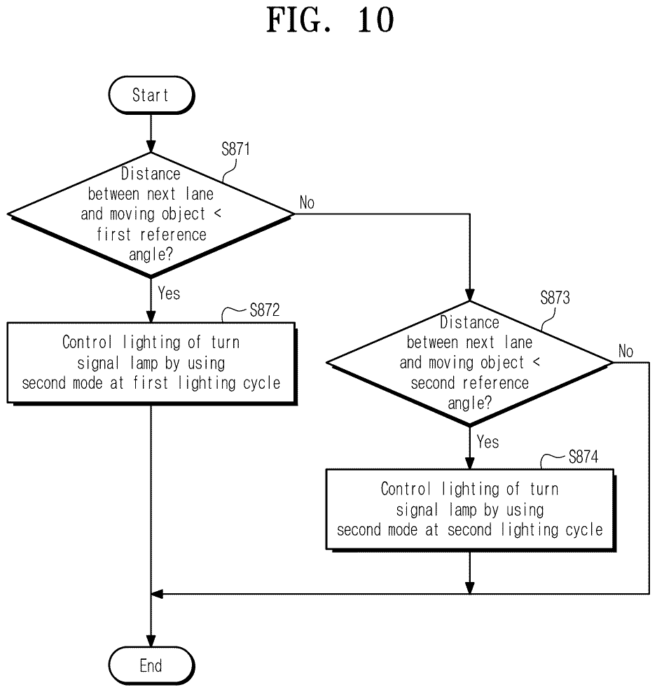

The turn signal lamp of the moving object 1000 is not used, and thus the lamp control system 10 may control the turn signal lamp according to a distance of the moving object from a next lane in the lane change direction or lane departure direction of the moving object 1000 (S870). This will be described below with reference to FIG. 10.

When the turn signal lamp of the moving object 1000 is used, the present method may be terminated. However, the present method may be performed regardless of whether the turn signal lamp of the moving object 1000 is not used (S860). That is, even if the turn signal lamp of the moving object 1000 is used, the lamp control system 10 may control the turn signal lamp according to a distance of the moving object from a next lane in the lane change direction or lane departure direction of the moving object 1000 (S870). In other words, the method may be implemented with S860 of FIG. 8 omitted.

S820 and S830 of FIG. 8 are information that may be detected by the sensor 200 of the moving object, and the information may be explained as being obtained by the lamp control system 10 from the sensor or the like. Alternatively, instead of whether to change lanes or depart from a lane, a condition for initiating control of a turn signal lamp based on refined data obtained by analyzing control information of the turn signal lamp according to the driving information described above may be used. That is, as illustrated in FIG. 4, based on position information about the frequency of lane changes or the frequency of use of a turn signal lamp, it is possible to modify the process below S830 to be performed when a current position of the moving object is higher than a preset reference for the frequency of lane changes or the frequency of use of a turn signal lamp.

FIG. 9 is a flowchart illustrating control of a turn signal lamp depending on a distance of a moving object from a next lane in a lane change direction or lane departure direction of the moving object 1000 when a driving mode is machine (autonomous) driving according to the present disclosure. FIG. 10 is a flowchart illustrating control of a turn signal lamp depending on a distance of the moving object from a next lane in a lane change direction or lane departure direction of the moving object 1000 is manual (driver) driving according to the present disclosure.

FIG. 9 is described first.

The lamp control system 10 may check whether the distance between the next lane and the moving object in the lane change direction or lane departure direction of the moving object 1000 is less than the first reference distance (S851).

When the distance between the next lane and the moving object 1000 in the lane change direction or lane departure direction is less than the first reference distance, the lamp control system 10 may be configured to control lighting of the turn signal lamp by using the first method at the first lighting speed (S852).

As the distance between the next lane and the moving object in the lane change direction or lane departure direction of the moving object 1000 is not less than the first reference distance, the lamp control system 10 may check whether the distance between the next lane and the moving object in the lane change direction or lane departure direction of the moving object 1000 is less than the second reference distance (S853). As described above, the first reference distance may be set to be less than the second reference distance.

When the distance between the next lane and the moving object 1000 in the lane change direction or lane departure direction is less than the second reference distance, the lamp control system 10 may be configured to control lighting of the turn signal lamp by using the first method at the second lighting speed (S854). As described above, the second lighting speed may be set to be less than the first lighting speed. That is, the lighting speed may be set to increase as the distance between the next lane and the moving object 1000 in the lane change direction or lane departure direction is reduced.

The method may be terminated when the distance between the next lane and the moving object in the lane change direction or lane departure direction of the moving object 1000 is not less than the first reference distance.

However, as described with reference to Table 2 and Table 3, a plurality (N) of reference distances, lighting speeds, and the like may be used to control the turn signal lamp according to the present disclosure. If N is 3 or greater, when the distance between the next lane and the moving object in the lane change direction or lane departure direction of the moving object 1000 is not less than the second reference distance, an additional operation may be added in which the distance between the next lane and the moving object in the lane change direction or lane departure direction of the moving object 1000 is compared with the third reference distance. In this case, when the distance between the next lane and the moving object 1000 in the lane change direction or lane departure direction is less than the third reference distance, the lamp control system 10 may control lighting of the turn signal lamp by using the first method at the third lighting speed. In this case, the third lighting speed may be set to be less than the second lighting speed. In this way, the procedure for comparison of the distance of the moving object to the next lane in the lane change direction or lane departure direction of the moving object and a corresponding lighting control, and the like may be performed N times.

FIG. 10 is described. FIG. 10 is performed, unlike FIG. 9, when a driving mode of the moving object 1000 is manual (driver) mode.

The lamp control system 10 may check whether the distance between the next lane and the moving object in the lane change direction or lane departure direction of the moving object 1000 is less than the first reference distance (S871).

When the distance between the next lane and the moving object 1000 in the lane change direction or lane departure direction is less than the first reference distance, the lamp control system 10 may be configured to control lighting of the turn signal lamp by using the second method at the first lighting cycle (S872).

As the distance between the next lane and the moving object in the lane change direction or lane departure direction of the moving object 1000 is not less than the first reference distance, the lamp control system 10 may check whether the distance between the next lane and the moving object in the lane change direction or lane departure direction of the moving object 1000 is less than the second reference distance (S873). As described above, the first reference distance may be set to be less than the second reference distance.

When the distance between the next lane and the moving object 1000 in the lane change direction or lane departure direction is less than the second reference distance, the lamp control system 10 may be configured to control lighting of the turn signal lamp by using the second method at the second lighting cycle (S874). As described above, the second lighting cycle may be set to be greater than the first lighting cycle. That is, a lighting cycle of the turn signal lamp may be set to decrease as the distance between the next lane and the moving object 1000 in the lane change direction or lane departure direction is reduced.

The method may be terminated when the distance between the next lane and the moving object in the lane change direction or lane departure direction of the moving object 1000 is not greater than the second reference distance.

However, as described with reference to Table 2 and Table 3, a plurality (N) of reference distances, lighting cycles, and the like may be used to control the turn signal lamp according to the present disclosure. If N is 3 or greater, when the distance between the next lane and the moving object in the lane change direction or lane departure direction of the moving object 1000 is not less than the second reference distance, an additional operation may be added in which the distance between the next lane and the moving object in the lane change direction or lane departure direction of the moving object 1000 is compared with the third reference distance. In this case, when the distance between the next lane and the moving object 1000 in the lane change direction or lane departure direction is greater than the third reference distance, the lamp control system 10 may control lighting of the turn signal lamp by using the second method at the third lighting cycle. In this case, the third lighting cycle may be set to be greater than the second lighting cycle. In this way, the procedure for comparing the distance of the moving object to the next lane in the lane change direction or lane departure direction of the moving object with a reference distance and a corresponding lighting control, and the like may be performed N times.

FIG. 11 illustrates a sequential lighting mode of a turn signal lamp according to the present disclosure. FIG. 11 illustrates lighting of a left turn signal lamp. (a) to (g) of FIG. 11 illustrate a lighting state of the turn signal lamp. (a) to (g) of FIG. 11 show a state in which the turn signal lamp is turned off.

(a) to (d) of FIG. 11 shows sequential lamping of the turn signal lamp. In (b) of FIG. 11, the turn signal lamp is lighted only for a region corresponding to TS1, and toward (c) and (d) of FIG. 11, the turn signal lamp is lighted for TS2 and TS3, respectively.

(d) to (g) of FIG. 11 shows sequential lamping of the turn signal lamp. In (e) of FIG. 11, the turn signal lamp is lighted only for a region corresponding to TS4, and toward (f) of FIG. 11, the turn signal lamp is lighted for TS5. (g) of FIG. 11 shows a state in which the turn signal lamp is turned off.

FIG. 12 illustrates a simultaneous lighting mode of a turn signal lamp according to the present disclosure. FIG. 12 illustrates lighting of a left turn signal lamp. (a) of FIG. 12 shows a state in which the turn signal lamp is turned off, (b) of FIG. 12 shows a state in which the turn signal lamp is turned on, and the turn signal lamp may be controlled to alternately execute the states shown in (a) and (b) of FIG. 12.

In this specification, data such as position-based driving information, a data-based frequency of lane changes, and data-based frequency of use of a turn signal lamp is not based on a usage history of only the moving object 1000, but corresponds to data obtained by collecting and processing lane changes, use of the turn signal lamp, and the like of all moving objects that drive on a corresponding road segment (i.e., the entire road segment). Naturally, the moving object 1000 may not have changed lanes, used a turn signal lamp, and the like on a corresponding road segment, or may not have driven on the corresponding road segment.

The contents of the present disclosure described in FIGS. 1 to 2 and FIGS. 4 to 12 described above, but not described with reference to FIG. 3, may be applied to the system 10 or the processor 610 thereof.

According to another embodiment of the present disclosure, a moving object or vehicle 1000 including the lamp control system 10 described above is proposed.

The present disclosure has the following effects.

The present disclosure provides control of a turn signal lamp based on driving information of a moving object, thereby not requiring a user or driver to operate a multi-function switch, and may notify surrounding vehicles of a lane change or lane departure of the moving object.

The effect of the present disclosure is not limited to the effect described above. Other effects not described above may be understood by those skilled in the art from the description of the present disclosure below.

In the above specification, the “system” for controlling a turn signal lamp or each component included therein is described as performing control, but the “device”, “system” and the components included therein are only names and the scope of rights is not dependent on thereon.

In other words, the proposed technology of the present disclosure may be performed by devices having names other than the processor, controller, etc. In addition, the method, scheme, or the like described above may be performed by software or code readable by a computer or other machine or device for lamp control.

In addition, as another aspect of the present disclosure, the operation of the proposed technology described above may be provided as code that may be implemented, realized, or executed by a “computer” (a generic concept including a system on chip (SoC) or a (micro) processor) or a computer-readable storage medium, a computer program product, or the like storing or containing the code. The scope of the present disclosure is extendable to the code or the computer-readable storage medium or the computer program product storing or containing the code.

Detailed descriptions of preferred embodiments of the present disclosure disclosed as described above have been provided such that those skilled in the art may implement and realize the present disclosure.

Although the present disclosure has been described above with reference to preferred embodiments, those skilled in the art will understand that various modifications and changes can be made to the present disclosure set forth in the claims below.

Accordingly, the present disclosure is not intended to be limited to the embodiments shown herein but is to be accorded the widest scope consistent with the principles and novel features disclosed herein.

It will be apparent to those skilled in the art that various modifications and variations can be made in the present disclosure without departing from the teaching or scope of the disclosures. Thus, it is intended that the present disclosure covers the modifications and variations of this disclosure provided they come within the scope of the appended claims and their equivalents.

What is claimed is:

1. A lamp control system for a moving object, comprising:
a turn signal lamp configured to output a turn signal;
a memory configured to store control information of the turn signal lamp based on driving information of the moving object; and
a processor configured to control the turn signal lamp according to the control information stored in the memory and the driving information of the moving object.

2. The lamp control system of claim 1, wherein the processor is configured to, based on the driving information indicating a lane change or lane departure, differently output the turn signal lamp depending on whether the driving information indicates a machine driving, an autonomous driving, or driving by a driver.

3. The lamp control system of claim 2, wherein the processor is configured to:
based on the driving information indicating the machine driving or the autonomous driving, control the turn signal lamp to be lighted according to a first lighting mode, and
based on the driving information indicating the driving by the driver, control the turn signal lamp to be lighted according to a second lighting mode.

4. The lamp control system of claim 3, wherein the processor is configured to control a lighting speed and lighting cycle of the turn signal lamp differently depending on a heading angle of the moving object indicated by the driving information.

5. The lamp control system of claim 4, wherein the processor is configured to:
based on the driving information indicating the machine driving or the autonomous driving, control one of the lighting speed and the lighting cycle of the turn signal lamp depending on a heading angle of the moving object, and
based on the driving information indicating the driving by the driver, control the other one of the lighting speed and the lighting cycle of the turn signal lamp depending on the heading angle of the moving object.

6. The lamp control system of claim 5, wherein the lighting speed is increased or the lighting cycle is decreased in accordance with an increase in the heading angle of the moving object.

7. The lamp control system of claim 3, wherein the processor is configured to control a lighting speed and lighting cycle of the turn signal lamp differently depending on a distance between a next lane and the moving object in a direction of lane change or lane departure indicated by the driving information.

8. The lamp control system of claim 7, wherein the processor is configured to:
based on the driving information indicating the machine driving or the autonomous driving, control one of a lighting speed and lighting cycle of the turn signal lamp depending on a distance between a next lane and the moving object in a lane change direction or lane departure direction of the moving object, and
based on the driving information indicating the driving by the driver, control the other one of the lighting speed and the lighting cycle of the turn signal lamp depending on the distance between the next lane and the moving object in the lane change direction or lane departure direction of the moving object.

9. The lamp control system of claim 8, wherein the lighting speed is increased or the lighting cycle is decreased as a distance between a next lane and the moving object in a direction of lane change or lane departure of the moving object becomes shorter.

10. The lamp control system of claim 3, wherein the first lighting mode includes a mode in which the turn signal lamp is sequentially lighted, and
the second lighting mode includes a mode in which the turn signal lamp is lighted simultaneously.

11. A lamp control method for a moving object, performed by a lamp control system including a turn signal lamp configured to output a turn signal, the lamp control method comprising:
obtaining driving information of the moving object; and
controlling the turn signal lamp according to control information of the turn signal lamp based on the driving information of the moving object.

12. The lamp control method of claim 11, further comprising, based on the driving information indicating a lane change or lane departure, differently outputting the turn signal lamp depending on whether the driving information indicates a machine driving, an autonomous driving, or driving by a driver.

13. The lamp control method of claim 12, further comprising, based on the driving information indicating the machine driving or the autonomous driving, controlling the turn signal lamp to be lighted according to a first lighting mode, and based on the driving information indicating the driving by the driver, controlling the turn signal lamp to be lighted according to a second lighting mode.

14. The lamp control method of claim 13, further comprising controlling a lighting speed and lighting cycle of the turn signal lamp differently depending on a heading angle of the moving object indicated by the driving information.

15. The lamp control method of claim 14, further comprising:
based on the driving information indicating the machine driving or the autonomous driving, controlling one of the lighting speed and the lighting cycle of the turn signal lamp depending on a heading angle of the moving object, and
based on the driving information indicating the driving by the driver, controlling the other one of the lighting speed and the lighting cycle of the turn signal lamp depending on the heading angle of the moving object.

16. The lamp control method of claim 15, wherein the lighting speed is increased or the lighting cycle is decreased in accordance with an increase in the heading angle of the moving object.

17. The lamp control method of claim 13, further comprising controlling a lighting speed and lighting cycle of the turn signal lamp differently depending on a distance between a next lane and the moving object in a direction of lane change or lane departure indicated by the driving information.

18. The lamp control system of claim 17, further comprising:
based on the driving information indicating the machine driving or the autonomous driving, controlling one of the lighting speed and the lighting cycle of the turn signal lamp depending on a distance between a next lane and the moving object in a lane change direction or lane departure direction of the moving object, or
based on the driving information indicating the driving by the driver, controlling the other one of the lighting speed and the lighting cycle of the turn signal lamp depending on the distance between the next lane and the moving object in the lane change direction or lane departure direction of the moving object.

19. The lamp control method of claim 13, wherein the first lighting mode includes a mode in which the turn signal lamp is lighted sequentially, and
the second lighting mode includes a mode in which the turn signal lamp is lighted simultaneously.

20. A moving object comprising:
a turn signal lamp configured to output a turn signal;
a memory configured to store control information of the turn signal lamp based on driving information of the moving object; and
a processor configured to control the turn signal lamp according to the control information stored in the memory and the driving information of the moving object.
